(19) United States
(12) Patent Application Publication
(10) Pub. No.: US 2005/0035137 A1
(43) Pub. Date: Feb. 17, 2005

(54) Core label dispenser

(76) Inventors: Tracey Glenn, Altadena, CA (US); Jaques Plummer, Ontario, CA (US); Robert Radi, Beverly Hills, CA (US); Jerry Hodsdon, Forestdale, MA (US); Michael Wu, West Corina, CA (US)

Correspondence Address: FULWIDER PATTON LEE & UTECHT, LLP;Howard Hughes Center, Tenth Floor, 6060 Center Drive, Los Angeles, CA, 90045, US

(21) Appl. No.: 10/772,105

(22) Filed: Feb. 3, 2004

Related U.S. Application Data
(60) Provisional application No. 60/444,845, filed on Feb. 3, 2003.

(51) Int. Cl. G07F 11/68; B65H 5/00; B65H 5/28; G07F 11/16

(52) U.S. Cl. 221/73; 221/235

(57) ABSTRACT

A label dispenser incorporates a roll of labels that is perforated in intervals using common label sizes. The dispenser is used as an alternative to traditional “core” handwritten labels. Current labels come on small sheets and are packaged in clear clamshell packages. The dispenser maintains a tension on the label tape that maintains the integrity of the perforation until time of use. The spool may have a ratchet mechanism that prevents the labels from retracting back into the dispenser mechanism. The ratchet mechanism also helps control the force applied by the user to dispense labels from the dispenser mechanism. Ideally, the dispenser is easy to use, compact, lightweight, and aesthetically appealing. Various different types and links of labels may be used, and the label dispenser accepts a common roll core. In some embodiments, the labels used for the product do not require a liner, thereby eliminating the need to peel off a label from a liner.

### CROSS-REFERENCE TO RELATED APPLICATION

This application claims priority from U.S. Provisional Patent Application No. 60/444,845, filed on Jun. 3, 2003 and entitled, “Core Label Dispenser,” the provisional application being incorporated by reference herein.

### BACKGROUND OF THE INVENTION

1. Field of the Invention

The present invention relates to label dispensers.

2. General Background and State of the Art

Various arrangements exist in the art for dispensing labels and the tapes. U.S. Pat. No. 6,227,406 discloses a device for dispensing a label from a backing strip that comprises a cartridge, a tab, and a detaching mechanism. The tab includes a first side, a second side and distal end. The detaching mechanism is configured to operatively cause the strip of backing material to be routed along each of the first and second sides of the tab and configured to detach the label from the strip of backing material as the corresponding strip of backing material traverses the distal end of said tab.

U.S. Pat. No. 6,394,165 discloses a dispenser and applicator device that dispenses self-adhesive elements from a roll having self-adhesive elements on a carrier tape. A separator separates the self-adhesive elements from the carrier tape, and the carrier tape is returned to a take-up wheel.

U.S. Pat. No. 5,806,713 discloses a device for dispensing and applying stamps, labels, stickers, and other self-adhesive products mounted on a backing web. Sliding the device across a contacting surface rotates the single moving part, a drive roller. The drive roller pulls the backing web around a delaminating bend. This separates the self-adhesive product from the web and applies it to the contacting surface. Some embodiments of the invention discharged the used webbing. The other embodiments automatically collect and store the webbing within their housings.

EP0837001 B1 discloses a label dispenser in the form of a hand held labeler that is selectively operable in a number of dispensed modes. The dispense modes include an on-demand mode in which labels are automatically printed and dispensed as previously printed labels are removed from the labeler. In a manual mode, the labeler is responsive to the manual actuation of a trigger switch to print and dispense a label.

U.S. Pat. No. 4,224,872 discloses a label strip jam preventing mechanism for use in hand labeler wherein the labeler is equipped with a feed mechanism having a feeding roller that is rotatably mounted on the frame of the hand labeler for feeding a continuous label strip. A label strip charging mechanism has a pressure plate covering the feeding roller for assuring engagement between the feeding roller and the label strip.

U.S. Pat. No. 5,017,412 discloses a system for dispensing labels for labeling goods which move in a single file past a labeling position, using a strip of labeling material in which labels are prepunched to leave adhesive bridges. The strip of labels is drawn from a supply to a dispenser. As a new label reaches the dispenser in a “ready” position, the preceding label arrives at the labeling position in a linear extension of its travel.

### INVENTION SUMMARY

One embodiment of a label dispenser according to the present invention has a housing with a first portion and a second portion. The first portion and the second portion are joined together to form the housing, with the housing having an interior. The dispenser also has a label spool that has a shaft to carry a roll of labels and a disc. The disc has a plurality of apertures spaced at regular intervals about the disc, at least one label being removably mounted on the shaft. A label spool retention shaft extends from the first portion of the housing into the interior of the housing. At least one aperture engagement prong extends from the first portion of the housing into the interior of the housing, the aperture engagement prong being in contact with the label spool disc, such that the prong engages successive aperture of the disc as the disc is rotated, thereby defining stops as the label spool disc is rotated. The label spool is rotatably mounted on the label spool retention shaft, and the housing has an opening through which a label may extend from inside the housing to outside the housing for dispensing the label.

Various embodiments of the invention may have particular features. A plurality of linerless labels may be mounted as a roll on the label spool or, alternatively, lined labels may be used. In the case of lined labels, the housing may provide means for separating the labels from the lining as the lining is pulled from the housing.

The first and second housing portions may be hinged to one another, or may be entirely separate, then joined to form the completed housing. In one embodiment, a second aperture engagement prong may extend from the first portion of the housing into the interior of the housing.

The housing portions may be made from a variety of different materials. For example, one or both housing portions may be formed of clear plastic. To stabilize the label dispenser on a flat surface, the housing may have a flat or relatively flat surface.

The second spool retention shaft extends into the interior of the first spool retention shaft. The label spool may be made of plastic, or any of a variety of other materials. The dispenser may be provided in a kit having at least one roll of labels of one label length and another roll of labels of another label length, both rolls of labels being interchangeably mountable within the dispenser.

The dispenser may further have flanges adjacent to the label spool retention shaft that extends from the first portion of the housing. The flanges may be adapted to secure the spool in place on the spool retention shaft. The aperture engagement prong may be integrally molded with the first housing portion, or may be a separate piece that is attached to the housing.

Considering another embodiment, a label dispenser has a housing comprising a first portion and a second portion, the first portion and the second portion being joined together to form the housing, the housing having an interior. The dispenser also has a label spool comprising a tubular shaft extending from the disc, said disc having a plurality of apertures spaced at regular intervals about the disc, at least one label being removably mounted on the tubular shaft. A label spool retention shaft extends from the first portion of the housing into the interior of the housing. At least one aperture engagement prong extends from the first portion of the housing into the interior of the housing, the aperture engagement prong being in contact with the label spool disc, such that the prong engages successive apertures of the disc as the disc is rotated, thereby defining click stops as the label spool disc is rotated.

In this embodiment, a second label spool retention shaft extends from the second portion of the housing. The label spool is rotatably mounted on the label spool retention shaft of the first portion of the housing. The housing has an opening through which a label may extend from inside the housing to outside the housing for dispensing the label.

The label spool may be constructed in a variety of ways. In one embodiment, the disc and the shaft are integrally molded, for example. Alternatively, the spool disc and the spool shaft may be separate pieces that are attached together. In one embodiment, the disc has prongs that are inserted into openings in the spool shaft to connect the pieces together.

Other aspects of the invention, as well as alternatives, are disclosed in the Detailed Description, the Drawings, and claims. Consequently, the invention is not limited to what is disclosed in this Summary of the Invention.

### BRIEF DESCRIPTION OF THE DRAWINGS

FIG. 1 is a perspective view of an embodiment of the label dispenser according to an embodiment of the present invention;

FIG. 2 is an exploded view of first and second portions of the label dispenser housing, along with the label spool having a shaft and the disc having a plurality of apertures spaced at regular intervals;

FIG. 3 is a detailed view showing the spool mounted on a spool retention shaft;

FIG. 4 is a detailed view illustrating aperture engagement prongs engaged with apertures in the disc of the label spool;

FIG. 5 is an exploded view showing a two-piece design for the label spool;

FIGS. 6a-c are a series of exploded views showing an alternative two-piece design for the label spool; and

FIG. 7a-c are a series of exploded views showing another two-piece design for the label spool.

### DETAILED DESCRIPTION OF THE PREFERRED EMBODIMENTS

A label dispenser according to the present invention typically incorporates a roll of labels that is perforated in intervals using common label sizes. In a preferred embodiment, the dispenser maintains a tension on the label tape that maintains the integrity of the perforation until time of use. The spool may have a ratchet mechanism that prevents the labels from retracting back into the dispenser mechanism. The ratchet mechanism may also help control the force applied by the user to dispense the labels from the dispenser mechanism. The dispenser is preferably refillable, such that the user may replace an old roll of labels with the new roll, as desired.

Preferably, the dispenser is easy to use, compact, lightweight, and aesthetically appealing. Various different types and lengths of labels may be used, and the label dispenser accepts a common roll core. In some embodiments, the labels on the label roll do not require a liner, thereby eliminating the need to peel off a label from a liner.

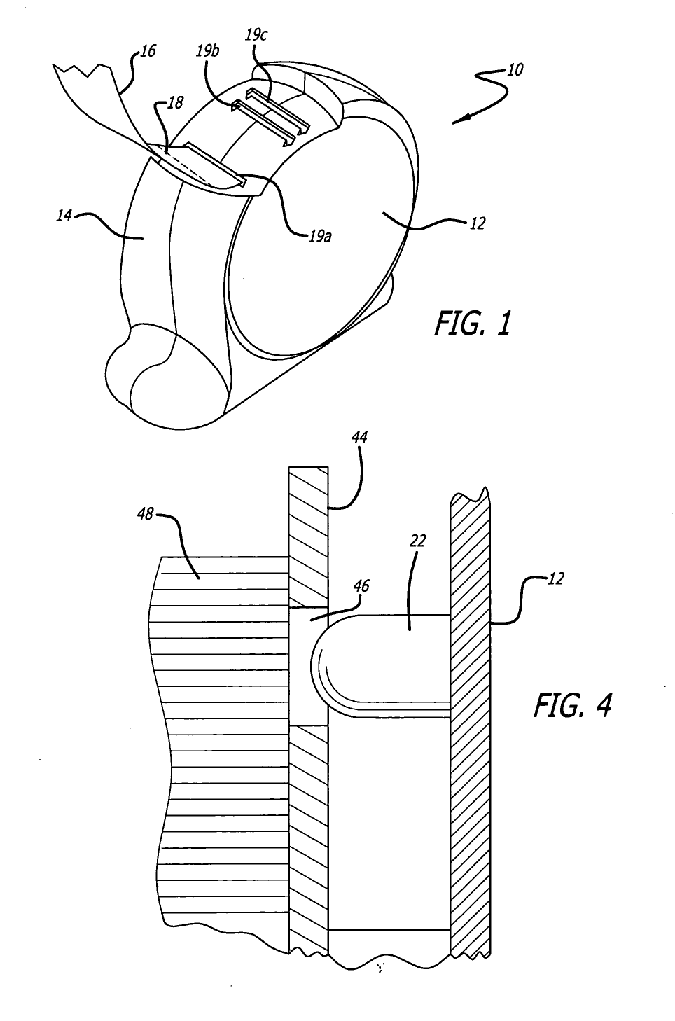

Considering one embodiment, FIG. 1 illustrates a label dispenser 10. The label dispenser 10 has a housing, with a first housing portion 12 and a second housing portion 14. The two housing portions may be separated from one another to open the housing. In one embodiment, the two housing portions are fit together by way of pins (not shown) on one of the housing portions, and holes on the opposing housing portions. The pins then fit into the holes to secure the housing halves together.

The label dispenser 10 houses labels 16, which are typically provided on a roll. The labels 16 may be perforated, as at 18, into standard-length labels. Different rolls of labels may typically be provided, with different lengths and/or types of labels, and the rolls interchanged by the user as desired, as will be explained further.

When a linerless roll of labels is used, the labels may exit the label dispenser 10 at label opening 198a. Alternatively, when labels having a standard release liner backing are used, label openings 19b and 19c may also be provided. As the user pulls the release liner through opening 19b, the labels are separated and exit the dispenser at 19c.

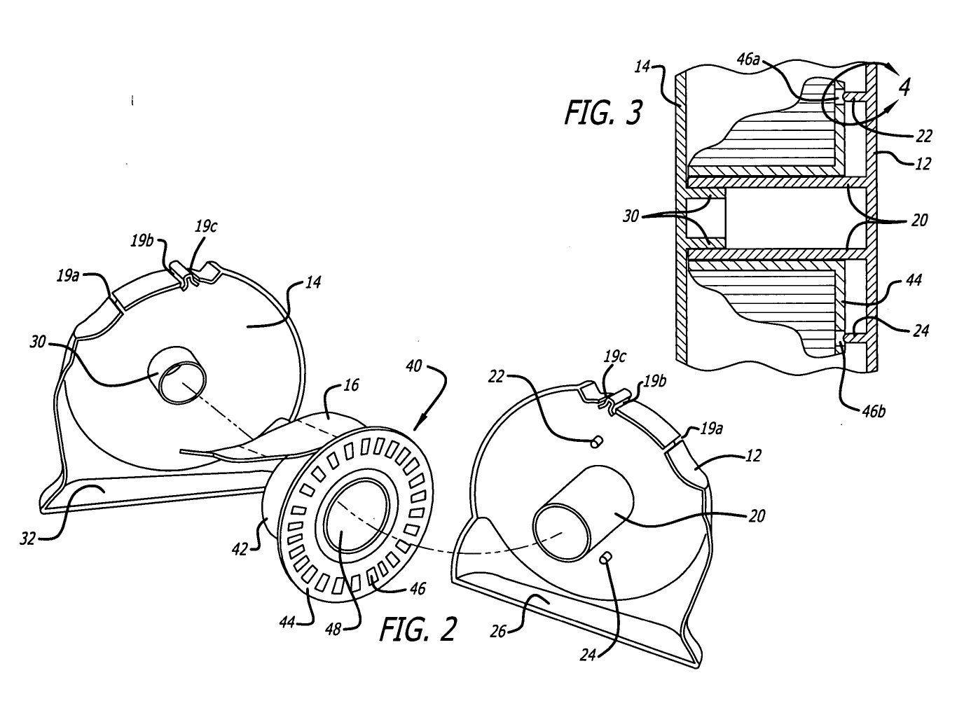

FIG. 2 illustrates components of the label dispenser 10. The first housing portion 12 includes a first label spool retention shaft 20. The first label spool retention shaft may be integrally molded with the housing portion, or may be attached separately. The first label spool retention shaft may also be braced, either internally within the shaft or externally about the shaft, with brace members (not shown) about the base of the shaft. The first housing portion 12 may also include one or more aperture engagement prongs, such as first aperture engagement prong 22 and second aperture engagement prong 24.

The first housing portion 12 may also include a base 26, at least a portion of which may be flat so that the housing portion may stand on a flat surface, such as a desktop or other useful surface.

Considering now the second housing portion 14, a second label spool retention shaft 30 extends from the housing. Typically, the second spool retention shaft 30 is narrower in diameter than the first to spool retention shaft 20, such that at least a portion of the second spool retention shaft 30 fits within the first spool retention shaft 20. This arrangement helps to interlock the first and second housing pieces when the housing is closed. The second portion of the housing 14 may also include a bottom surface 32 that is relatively flat, so that the housing portion may stand on a flat surface.

The assembly also includes a label spool 40 that carries a roll 42 of labels. The label spool comprises a shaft to carry the roll of labels and a disc 44. The disc 44 has a plurality of apertures 46 spaced about the disc. As will be described further, these apertures 46 are sequentially engaged by the aperture engagement prongs 22 and 24 (in the embodiment of FIG. 2). Consequently, when the label spool 40 is mounted on the label spool retention shaft 20, and with the second label spool retention shaft 30 engaged with the first label spool retention shaft 20 and the housing in the closed position, the label spool disc “clicks” as it is rotated.

The apertures 46 may be rectangular. However, in one embodiment, the apertures 46 are tapered, and are narrower near the center of the disc and wider nearer to the edge of the disc. This assists in fitting the disc on the prongs during assembly. In one embodiment, the width of the apertures nearest the center of the disc is 0.0740 inches, whereas the width of the apertures nearest to the edge of the disc is 0.1085 inches. Other dimensions may be used, of course, as well as other shapes.

That is, the combination of the apertures and the prongs create discrete radial stops, forming a ratchet mechanism. The ratchet effect prevents the labels from retracting back into the dispenser mechanism. The ratchet mechanism may also help control the force applied by the user to dispense the labels from the dispenser mechanism such, as for example, when the user pulls too hard on the label strip. The ratchet mechanism acts to slow the rate at which the labels leave the housing.

A label spool shaft 48 carries the roll of labels 42. The roll of labels 42 is typically removable from the spool shaft 48, such that a variety of different rolls of labels may be used interchangeably. A user may have, for example, different rolls of labels of different sizes, and may remove one roll and replace it with another, as desired.

FIG. 3 is a cross-section of the assembly in the closed configuration, with the first and second aperture engagement prongs 22, 24 engaged in respective apertures 46a and 46b on the label spool disc 44. The specific aperture in engagement with the aperture engagement prongs will depend on the position of the disc 44, and change as the disc rotates when the user pulls on the strip of labels.

FIG. 3 illustrates the second outer housing portion 14 having second label spool retention shaft 30. The spool retention shaft 30 is inserted into the first label spool retention shaft 20, thereby securing the second portion of the housing 14 in position relative to the first outer housing portion 12. The housing portions 12 and 14 may be adapted to snap together along the edges in order to secure the housing.

FIG. 4 shows in more detail the aperture engagement prong 22 engaged in a label spool disc aperture 46. In this embodiment, the prong 22 is rounded so as to facilitate engagement and disengagement with the aperture 46 as the user rotates disc 44 by pulling on the strips of labels from the roll.

The label spool 40 may be constructed in a variety of ways. It may be integrally molded, for example. Alternatively, the spool disc 44 and the spool shaft 48 may be separate pieces that are attached together. FIG. 5 illustrates one such design, in which the label disc includes prongs. In a preferred embodiment, the prongs press-fit into receptor apertures to join the spool disc to the spool shaft.

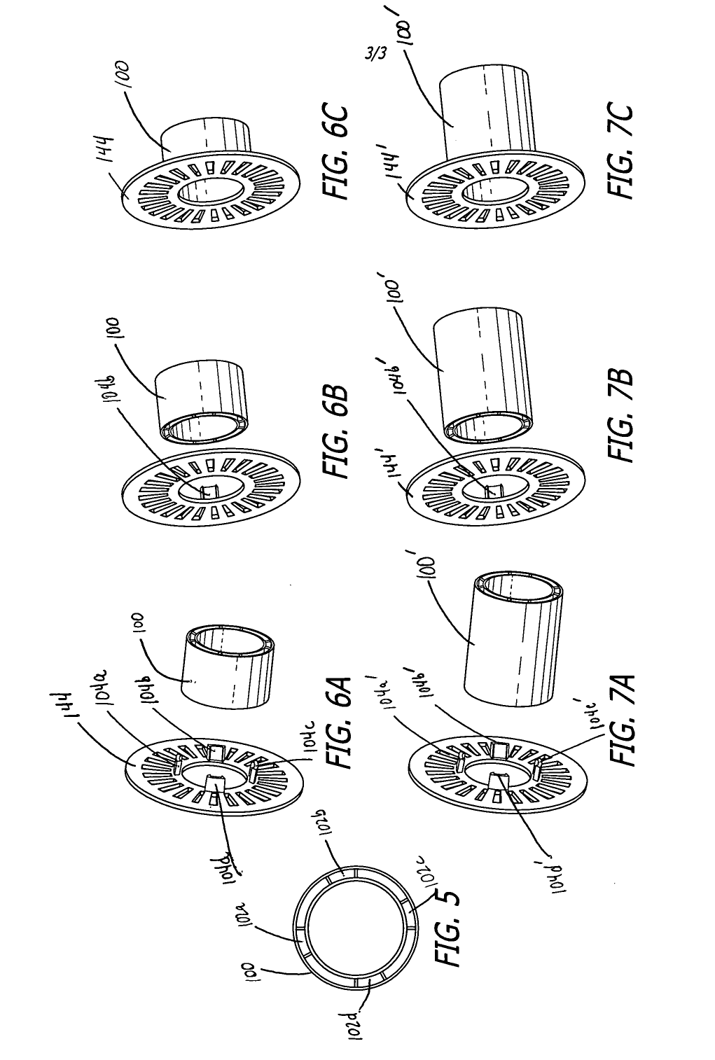

FIG. 5 is an end view of a spool retention shaft that is to be press-fit onto the disc 144. The spool retention shaft 100 has prong receptors 102a-d, in which corresponding prongs 104a-d will be press-fit. Referring to FIGS. 6a-6c, the process of press-fitting the spool shaft 100 onto the spool disc 144 is illustrated. The receptacles 102a-d are slightly smaller in width than the corresponding prongs 104a-d, so that the fit is tight.

FIGS. 7a-c show the same press-fit operation as in FIGS. 6a-c, but with an alternative embodiment in which the spool retention shaft 100′ is somewhat longer than in the embodiment of FIG. 6.

Any of a variety of materials may be used to construct the dispenser. The outer housing is typically a molded plastic, such as polystyrene. The label spool disc 44 and the label spool shaft 48 may be formed from polypropylene, for example

While the specification describes particular embodiments of the present invention, those of ordinary skill can devise variations of the present invention without departing from the inventive concept.

1. A label dispenser comprising:
a housing comprising a first portion and a second portion, said first portion and said second portion being joined together to form the housing, said housing having an interior;
a label spool comprising a shaft to carry a roll of labels and the disc, said disc having a plurality of apertures spaced at regular intervals about the disc, at least one label being removably mounted on said shaft;
a label spool retention shaft extending from said first portion of said housing into said interior of said housing;
at least one aperture engagement prong extending from said first portion of said housing into the interior of said housing, said aperture engagement prong being in contact with said label spool disc, such that said prong engages successive apertures of said disc as said disc is rotated, thereby defining stops as the label spool disc is rotated;
said label spool being rotatably mounted on the label spool retention shaft;
said outer housing having an opening through which a label may extend from inside said housing to outside said housing for dispensing said label.

2. A label dispenser as defined in claim 1, further comprising a plurality of linerless labels mounted as a roll on said label spool.

3. A label dispenser as defined in claim 1, wherein said first and second housing portions are hinged to one another.

4. A label dispenser as defined in claim 1, wherein a second aperture engagement prong extends from said first portion of said housing into the interior of said housing.

5. A label dispenser as defined in claim 1, wherein at least one housing portion is formed of clear plastic.

6. A label dispenser as defined in claim 1, wherein said housing has a bottom, the bottom comprising a relatively flat surface for stabilizing the label dispenser on a flat surface.

7. A label dispenser as defined in claim 1, wherein said second spool retention shaft extends into the interior of first spool retention shaft.

8. A label dispenser as defined in claim 1, wherein said label spool is plastic.

9. A label dispenser as defined in claim 1, wherein said dispenser is provided in a kit having at least one roll of labels of one label length and another roll of labels of another label length, both rolls of labels being interchangeably mountable within said dispenser.

10. A label dispenser as defined in claim 1, wherein the dispenser further comprises flanges adjacent to said label spool retention shaft that extends from said first portion of said housing, said flanges adapted to secure said spool in place on said spool retention shaft.

11. A label dispenser as defined in claim 1, wherein said aperture engagement prong is integrally molded with said first housing portion.

12. A label dispenser as defined in claim 1, wherein said apertures are tapered.

13. A label dispenser as defined in claim 1, wherein said label spool shaft and said label spool disc are separate pieces.

14. A label dispenser comprising:
a housing comprising a first portion and second portion, said first portion and said second portion being joined together to form the housing, said housing having an interior;
a label spool comprising a tubular shaft extending from a disc, said disc having a plurality of apertures spaced at regular intervals about the disc, at least one label being removable mounted on said tubular shaft;
a label spool retention shaft extending from said first portion of said housing into said interior of said housing;
at least one aperture engagement prong extending from said first portion of said housing into the interior of said housing, said aperture engagement prong being in contact with said label spool disc, such that said prong engages successive apertures of said disc as said disc is rotated, thereby defining click stops as the label spool disc is rotated;
a second label spool retention shaft extending from said second portion of said housing;
said label spool being rotatably mounted on the label spool retention shaft of said first portion of said housing; and
said housing having an opening through which a label may extend from inside said housing to outside said housing for dispensing said label.

15. A label dispenser as defined in claim 14, further comprising a plurality of linerless labels mounted on said label spool.

16. A label dispenser as defined in claim 14, wherein said first and second housing portions are hinged to one another.

17. A label dispenser as defined in claim 14, wherein a second aperture engagement prong extends from said first portion of said housing into the interior of said housing.

18. A label dispenser as defined in claim 14, wherein at least one housing portion is formed of clear plastic.

19. A label dispenser as defined in claim 14, wherein said housing has a bottom, the bottom comprising a relatively flat surface for stabilizing the label dispenser on a flat surface.

20. A label dispenser as defined in claim 14, wherein said second spool retention shaft extends into the interior of the first spool retention shaft.

21. A label dispenser as defined in claim 14, wherein said label spool is plastic.

22. A label dispenser as defined in claim 14, wherein said dispenser is provided in a kit having at least one roll of labels of one label length and another roll of labels of another label length, both rolls of labels being interchangeably mountable within said dispenser.

23. A label dispenser as defined in claim 14, wherein the dispenser further comprises flanges adjacent to said label spool retention shaft that extends from said first portion of said housing, said flanges adapted to secure said spool in place on said spool retention shaft.

24. A label dispenser as defined in claim 14, wherein said aperture engagement prong is integrally molded with said first housing portion

25. A label dispenser as defined in claim 14, wherein said apertures are tapered.

26. A label dispenser comprising:
a housing;
means for removably retaining a roll of labels within the housing; and
means for incrementally advancing labels on said roll of labels.
